(19) United States
(12) Patent Application Publication
(10) Pub. No.: US 2015/0123992 A1
(43) Pub. Date: May 7, 2015

(54) METHOD AND APPARATUS FOR HEADS-DOWN DISPLAY

(71) Applicant: QUALCOMM Incorporated, San Diego, CA (US)

(72) Inventors: Michael MAHAN, San Diego, CA (US); Mark LINDNER, San Diego, CA (US)

(73) Assignee: QUALCOMM Incorporated, San Diego, CA (US)

(21) Appl. No.: 14/071,202

(22) Filed: Nov. 4, 2013

(51) Int. Cl. G06T 11/60; H04N 7/18

(52) U.S. Cl. CPC G06T 11/60; H04N 7/181; G06T 2219/028
USPC 345/629

(57) ABSTRACT

Techniques for providing a heads-down display on a wireless device are described. An environmental signal representing actual images may be received from one or more cameras associated with the wireless device. The actual images may be of a physical environment in proximity to a current location of the wireless device. An application signal, representing application renderings associated with an application currently executing at the wireless device, may be received. The actual images and the application renderings may be simultaneously rendered on a screen associated with the wireless device. The actual images and the application renderings may be rendered as ordered layers on the screen.

### BACKGROUND

Aspects of the present disclosure relate generally to wireless communications and, more particularly, to a method and apparatus for a heads-down display.

Personal wireless devices (e.g., Smartphones, tablets, and the like) include applications that render compelling user experiences. Users immerse themselves with these applications, sometimes at their own peril. For example, users may create danger to others, as these users continue to interact, mostly unconsciously, with their physical environment while absorbed in the use of the device.

As such, improved techniques to ensure users of wireless devices are aware of their surroundings may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method for providing a heads-down display on a wireless device is described. The method may include receiving an environmental signal representing actual images from one or more cameras. The one or more cameras may be associated with the wireless device. The actual images may be of a physical environment in proximity to a current location of the wireless device. The method may include receiving an application signal representing application renderings associated with an application currently executing at the wireless device. The method may include simultaneously rendering the actual images and the application renderings on a screen associated with the wireless device. The actual images and the application renderings may be rendered as ordered layers on the screen.

In an aspect, a computer program product for providing a heads-down display on a wireless device comprising a non-transitory computer-readable medium including code is described. The code may cause a computer to receive an environmental signal representing actual images from one or more cameras. The one or more cameras may be associated with the wireless device. The actual images may be of a physical environment in proximity to a current location of the wireless device. The code may cause a computer to receive an application signal representing application renderings associated with an application currently executing at the wireless device. The code may cause a computer to simultaneously render the actual images and the application renderings on a screen associated with the wireless device. The actual images and the application renderings may be rendered as ordered layers on the screen.

In an aspect, a wireless device apparatus for providing a heads-down display is described. The wireless device apparatus may include one or more cameras associated with the wireless device and configured to receive an environmental signal representing actual images. The actual images may be of a physical environment in proximity to a current location of the wireless device. The wireless device apparatus may include an application component configured to receive an application signal representing application renderings associated with an application currently executing at the wireless device. The wireless device apparatus may include a rendering component configured to simultaneously render the actual images and the application renderings on a screen associated with the wireless device. The actual images and the application renderings may be rendered as ordered layers on the screen.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram of a user operating a wireless device, having aspects configured for providing a heads-down display, in a physical environment according to the present aspects;

FIG. 2 is a diagram illustrating an example of a screen of a wireless device, having aspects configured for providing a heads-down display, displaying an application rendering;

FIG. 3 is a diagram illustrating an example of a screen of a wireless device, having aspects configured for providing a heads-down display, displaying an application rendering and an actual image in different portions of the screen;

FIG. 4 is a diagram illustrating an example of a screen of a wireless device, having aspects configured for providing a heads-down display, displaying an application rendering and an actual image as ordered layers;

FIGS. 5A and 5B are diagrams illustrating possible form factors and camera positions by showing a side of a wireless device, having aspects configured for providing a heads-down display;

FIG. 5C is a diagram illustrating possible form factors and camera positions by showing a top of a wireless device, having aspects configured for providing a heads-down display;

FIGS. 6A and 6B are diagrams illustrating possible form factors and camera positions by showing a back pane of a wireless device, having aspects configured for providing a heads-down display;

FIG. 7 is a diagram illustrating an example of components included within a wireless device having aspects configured for providing a heads-down display;

FIG. 8 is a flow chart of a method for providing a heads-down display at a wireless device; and

FIG. 9 is a diagram illustrating an apparatus employing a processing system having aspects configured for providing a heads-down display.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Users of wireless devices (e.g., Smartphones, tablets, and the like) may interact with the increasingly capable devices visually, tactilely, or audibly, and in various combinations of the three. Wireless device capabilities, and applications that exploit them, require increasing user attention and focus, especially visually and tactilely. While operating such devices, users often choose, or are required, to simultaneously interact with their immediate “real world,” physical environment. If the user operates her device while she is relatively static but is located in a highly volatile environment, or the user operates her device while she is physically moving through some complex environment, the user may put herself and others in danger. In both cases, typically the user interacts with her device using her primary sensory focus while simultaneously interacting with the physical environment using her secondary sensory focus. By using only secondary focus to interact with the surrounding physical environment, the user loses information that can be highly valuable and/or critical to the user's safety, either in real time or in future considerations or actions.

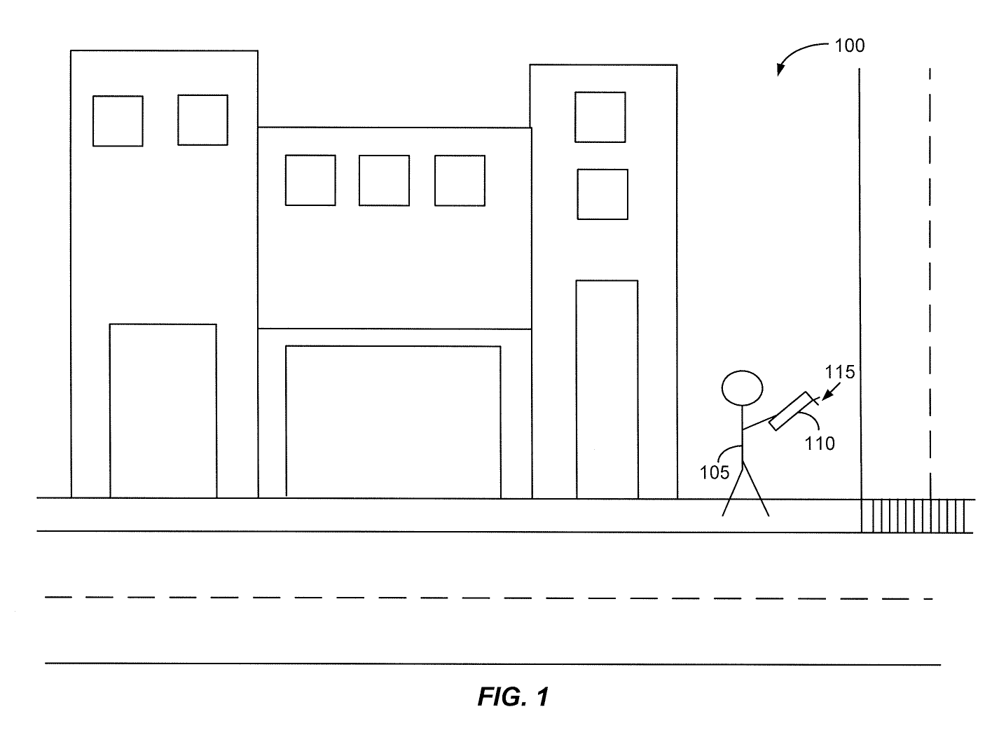

As an example, and referring to FIG. 1, a user 105 may be located in an external, physical environment 100. The user 105 may be walking down a crowded street while using her device 110 and completely fail to see that she is about to step off a curb and enter a crosswalk. Because the user 105 is only applying secondary (and, not much at that) focus to her physical environment 100, she is likely to not see the curb, crosswalk, or other pedestrians or obstacles and, as a result of this ignorance, trip over the curb, bump into another person or object, or, worse, walk into oncoming traffic. By doing so, user 105 is likely to cause injury to herself, others, and probably wireless device 110.

However, if user 105 is more aware of the surrounding physical environment 100, she may be safer (and less likely to cause injury to others); however, she also may have a poor application experience because she is constantly taking focus off of the screen of device 110 (and the user experience) to visually scan her physical surroundings.

According to the present aspects, and still referring to FIG. 1, wireless device 110 may provide a heads-down display. More particularly, wireless device 110 may be configured to render on a screen of wireless device 110 environmental signals representing one or more actual images of physical environment 100, which may be captured by one or more cameras 115, which is currently proximate to wireless device 110 and user 105. The environmental signals representing actual images of physical environment 100 may be captured by one or more cameras 115. The actual image of physical environment 100 may be displayed along with an application rendering related to an application executing on wireless device 110, such as, but not limited to, an email client, a game, a music player, a news application, and/or the like. The actual images and the application rendering may be displayed as ordered layers on the screen of wireless device 110 where, in an aspect, the actual image is layered over (or on top of) the application rendering, such that a least a portion of the actual image overlaps with the application rendering. In another aspect, the actual image and the application rendering may be rendered on different portions of the screen of wireless device 110. In an aspect, information related to the immediate physical environment 100 of wireless device 110 (and user 105) also may be represented to user 105 via other modalities, such as an audio or haptic (e.g., tactile) indication.

Such a heads-down display may improve the application experience for user 105 when she is interacting with wireless device 110, while simultaneously allowing user 105 to safely navigate through her physical environment 100 by allowing user 105 to keep her visual focus in one place.

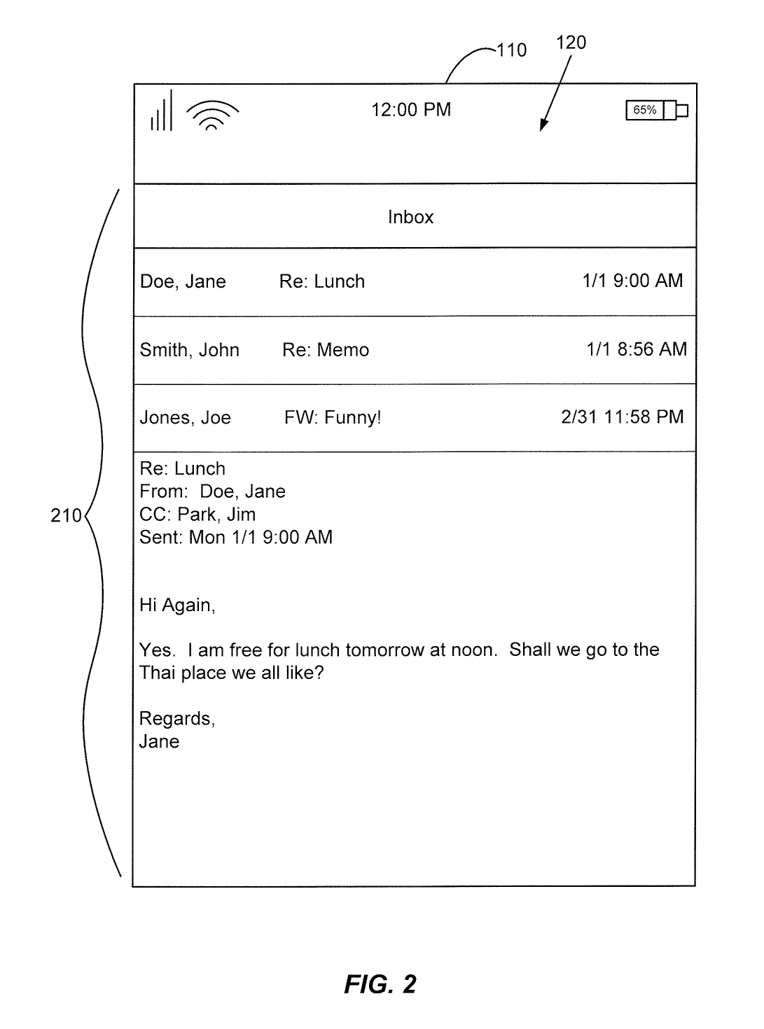

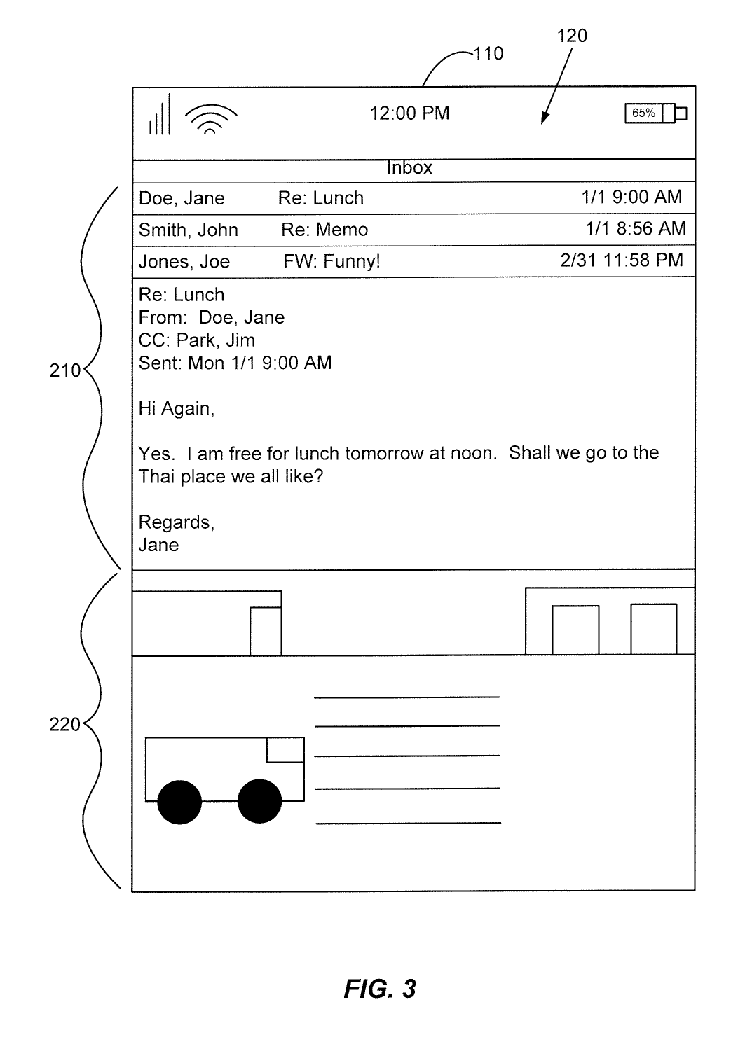

Referring to FIGS. 2, 3, and 4, a screen 120 of wireless device 110 is configured to display information and images to user 105. In the example of FIG. 2, application rendering 210 associated with an email application is currently rendered on screen 120. In the example of FIG. 3, application rendering 210 associated with the email application is still rendered on screen 120; however, an actual image 220 representing physical environment 100 (which is proximate to wireless device 110 as described herein) is also rendered on screen 120. In the example of FIG. 3, application rendering 210 is rendered on a portion of screen 120 (e.g., the top portion) and actual image 220 is rendered on a different portion of screen 120 (e.g., the bottom portion). In the example shown in FIG. 3, actual image 220 does not overlap any portion of application rendering 210 (e.g., the entire email inbox and current message are still displayed).

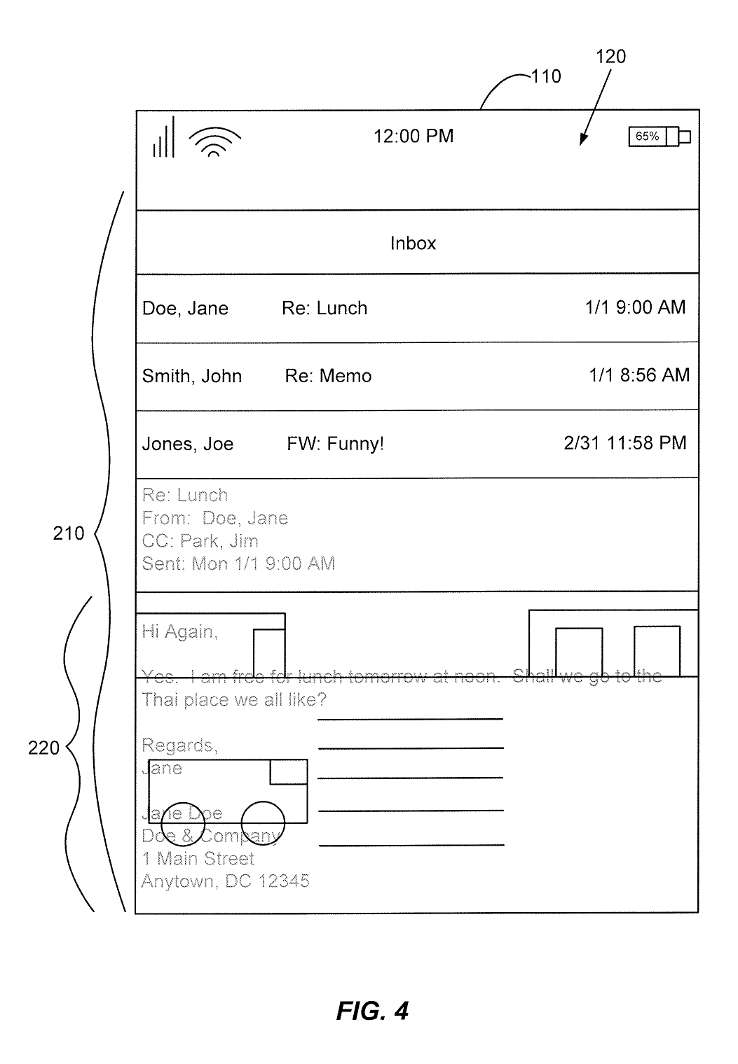

In the example of FIG. 4, application rendering 210 and actual image 220 are rendered on screen 120 as ordered layers of visual information. More particularly, application rendering 210 is rendered on screen 120 and, in this example, covers the entire area of screen 120. Actual image 220 is also rendered on screen 120 such that it is rendered translucently, that is with a low level of opacity, and overlapping a portion of application rendering 210. More particularly, actual image 220 is rendered on screen 120 on top of a portion of application rendering 210 in such a way that the overlaid portion of application rendering 210 can still be perceived by user 105 while user 105 is also made aware of her physical environment 100 by the rendering of actual image 220. In the example of FIG. 4, user 105 can maintain her immersive experience with the email application, while simultaneously being aware of her physical environment 100 as a result of actual image 220 being overlaid on top of application rendering 210.

It will be understood that the present aspects are not limited to the specific examples of FIGS. 3 and 4. In an aspect, actual image 220 may overlap some portion of application rendering 210. In an aspect, actual image 220 and application rendering 210 may be rendered on different portions of screen 120, such as, for example, actual image 220 may be rendered on the top portion of screen 120 while application rendering 210 may be rendered on the bottom portion of screen 120, one of application rendering 210 and actual image 220 may be rendered on the left portion of screen 120 and the other one of application rendering 210 and actual image 220 may be rendered on the right portion of screen 120, and/or actual image 220 may be rendered in the middle of (e.g., overlapping at least a portion of) application rendering 210. In any one of these examples, application rendering 210 and actual image 220 may be rendered on screen 120 as ordered layers of visual information, such that actual image 220 is rendered as an overlay on top of application rendering 210 with varying levels of opacity.

As described herein, actual image 220 may be rendered on screen 120 of wireless device 110 with varying levels of opacity, such that even though actual image 220 is rendered as an ordered layer on top of application rendering 210, user 105 of wireless device 110 can still perceive application rendering 210 to some extent or degree. At one end of a spectrum is a complete takeover of screen 120 by actual image 220, causing obfuscation of application rendering 210, such that the heads-down experience becomes a heads-up experience. At the other end of the spectrum, application rendering 210 may be the only image rendered on screen 120—no information about physical environment 100 is displayed. In the middle of the spectrum, and most usefully, actual image 220 may be rendered on screen 120 as a translucent ordered layer overlaid on top of application rendering 210, such that user 105 could easily perceive both application rendering 210 and actual image 220.

In an aspect, the level of opacity of actual image 220 when rendered on screen 120 can be a default setting, e.g., a setting by a manufacturer of wireless device 110, installer of an operating system of wireless device 110, network services operator, and/or the like. In an aspect, the level of opacity may have been previously-defined by user 105, such that user 105 selects a setting related to a preferred level of opacity for actual image 220.

In an aspect, the level of opacity may be dynamically determined by wireless device 110 based on a determination as to whether a triggering event, such as, for example, a dangerous situation or potential collision exists in physical environment 100. In one non-limiting example, a triggering event may be a situation in which user 105 is about to step off a curb into a crosswalk and, potentially, oncoming traffic. Another, non-limiting example, is a situation in which wireless device 110 determines, based on, e.g., GPS data, that wireless device 110 is located in a dense city and, as such, user 105 should be more aware of physical environment 100. In such a case, the level of opacity may increase when a situation calls for increased awareness by user 105 of physical environment 100, and the level of opacity of actual image 220 may decrease when such a scenario is not present.

In an aspect, the level of opacity may be set by user 105 at the time that actual image 220 is rendered on screen 120. For example, a virtual or hardware-based switch, such as a volume rocker on a device, may be employed by user 105 to vary the opacity of actual image 220 to control the level of intrusion over application rendering 210. In another aspect, a device may include a multi- or dual-mode volume rocker switch, which would allow user 105 to indicate that she was using the rocker switch to control the opacity level of actual image 220, rather than audio volume. For example, a middle portion of the switch (which may be felt tactilely by a hump, depression, or striation) may be activated to indicate additional functionality requests. Once clicked in the middle, user 105 may receive some indication that the function of the rocker has been reset from volume control to opacity level control.

Similarly, and in another aspect, camera 115 of wireless device 110 may not capture environmental signals representing actual images of physical environment 100 unless, and until, a triggering event occurs. For example, under normal operation (e.g., a default setting), camera 115 may not capture environmental signals representing actual images of physical environment 100; however, when a triggering event is detected by wireless device 110, camera 115 may be directed to begin capturing the environmental signals representing actual images of physical environment 100 and rendering actual image 220 to screen 120 of wireless device 120. In such an aspect, the capturing of environmental signals that represent actual images by camera 115 and displaying actual image 220 with a particular (e.g., high) level of opacity may be based on different thresholds of the particular triggering event. In one non-limiting example, detecting that wireless device 110 is located in a dense city may cause camera 115 to begin capturing environmental signals that represent actual images, while detecting that a dangerous situation is occurring (or potentially occurring) in physical environment 100 may trigger rendering actual image 220 on screen 120 with a high level of opacity.

In another aspect and non-limiting example, wireless device 110 may be configured to specifically help user 105 avoid tripping hazards or potential collisions, e.g., hazards at the feet of user 105. For example, when activated (e.g., triggered by a dangerous situation or the like as described herein), an angle of camera 115 and/or a camera lens of camera 115, may be adjusted (dynamically, automatically, and/or manually) to “look for” ground obstacles (e.g., cracks in the sidewalk, glass on the ground, small dogs) in the area at the feet of user 105. In an aspect, object identification software may be used to determine whether such a tripping hazard exists in the actual images represented by environmental signals captured by camera 115 and, if so, the actual image 220 may be rendered on screen 120 with a level of opacity that will help user 105 avoid the tripping hazard.

In an aspect, rather than rendering actual image 220 on screen 120 and/or providing other multi-modal alerts to user 105 to alert her to physical environment 100, wireless device 110 may be configured to render representations of physical objects that are present in physical environment 100 on screen 120. Object identification software may be used to process actual images determined from environmental signals captured by camera 115 and determine if the actual images include an object that may pose a potential danger to user 105 or an object that user 105 may be interested in knowing is in her path. Furthermore, a proximity sensor may be included within wireless device 110 to determine how close (or far) user 105 is from the detected objects. In such an aspect, rather than rendering actual image 220 on screen 120 as an overlay on top of application rendering 210, wireless device 110 may be configured to render representations of objects found in physical environment 100, which may be an icon that represents an object, clip art of the object, and/or text identifying the object, as an overlay on top of application rendering 210. An indication as to the proximity of the object to user 105 also may be provided via the rendering of the representations of the objects (e.g., a number of feet or meters may appear with the representation). Similar to the rendering of actual image 220, representations of objects may be rendered with varying levels of opacity determined as described herein.

In an aspect, wireless device 110 may be configured to provide information to user 105 about physical environment 100 using a broader set of modalities instead of, or in addition to, providing a visual indication (e.g., actual image 220). For example, wireless device 110 may be configured to sound an alert in order to inform user 105 to pay attention to her environment. In another example, wireless device 110 may be configured to provide a haptic or tactile alert, such as a vibration of wireless device 110, a “kick back” of wireless device 110, and/or the like. In yet another example, a combination of visual, audio, and haptic (or tactile) alerts may be used simultaneously. These multi-modal alerts may be provided by wireless device 110 at varying levels of intensity—more intense alerts (e.g., stronger vibrations, louder sounds) may be used when a triggering event is detected, while less intense alerts (e.g., a single vibration, a low tone) may be used when such a scenario is not present. Such alert or alerts may, in a non-limiting example, indicate that actual image 220 is about to be rendered on screen 120, that physical environment 100 is particularly dangerous and user 105 should look up, or that a (user-configurable or default) situation exists in physical environment 120 (e.g., the coffee shop favored by user 105 is up ahead).

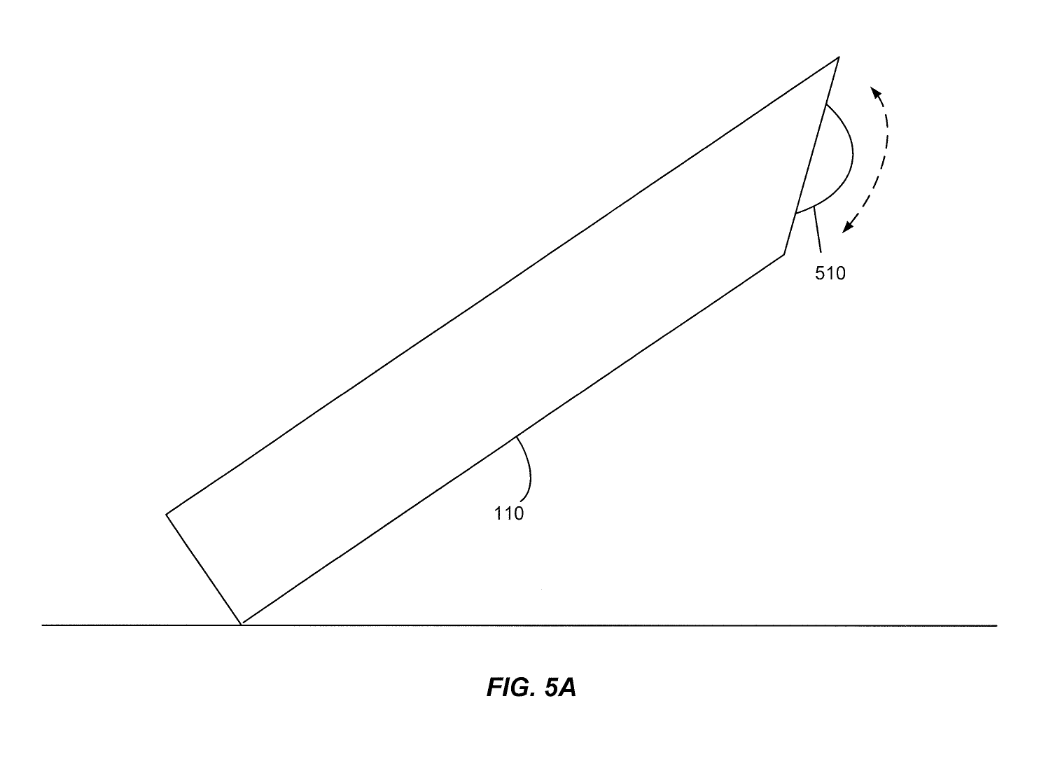

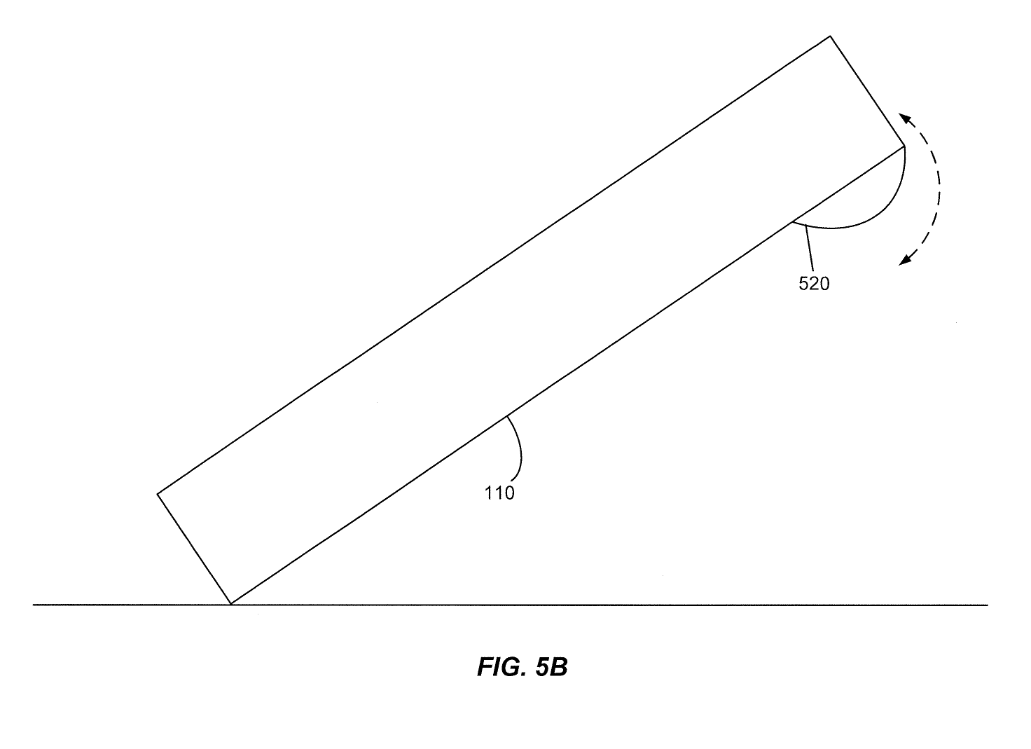

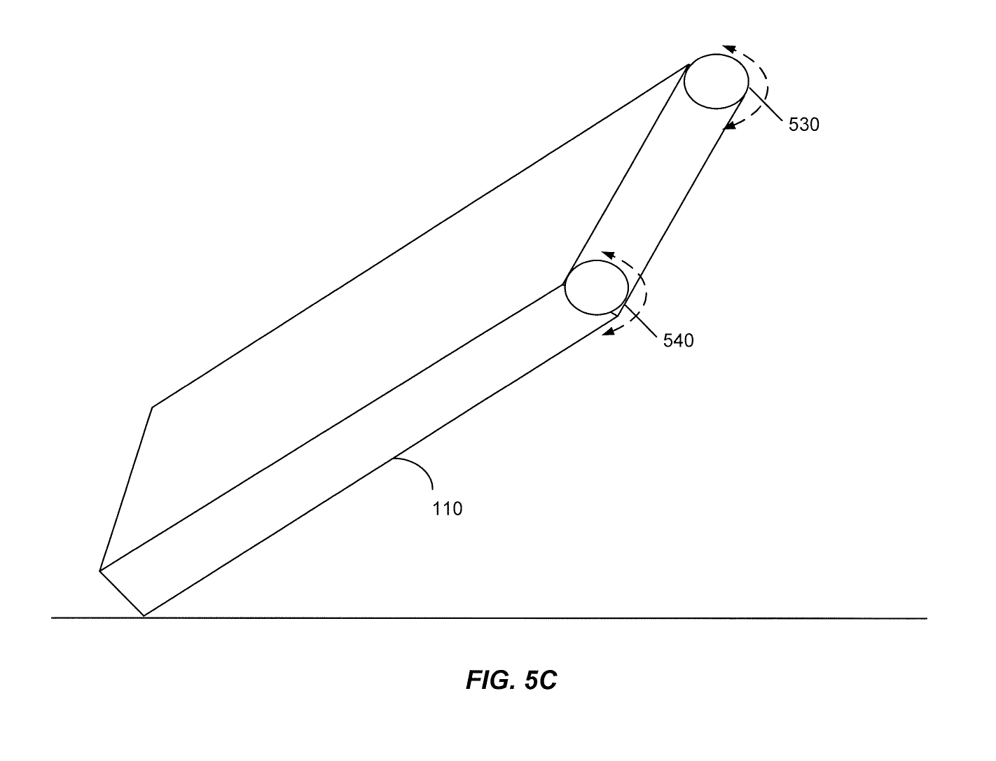

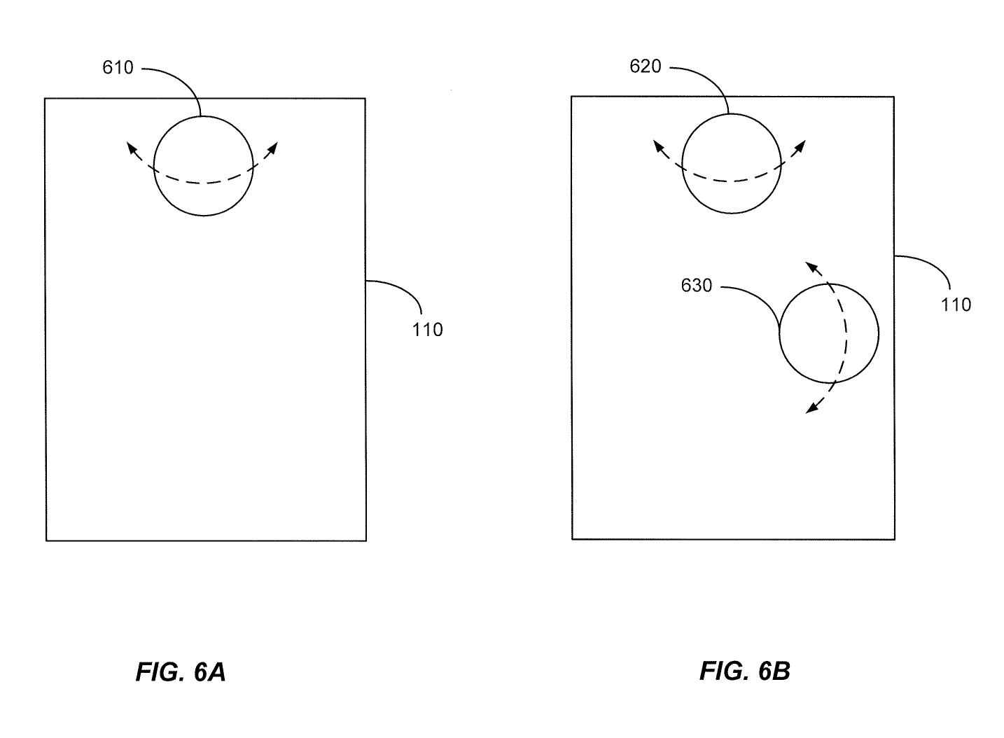

Referring to FIGS. 5A, 5B, 5C, 6A, and 6B, various form factors for wireless device 110 may include one or more cameras 510, 520, 530, 540, 610, 620, and/or 630 positioned in different locations. Cameras 510 and 520 are positioned on a side of wireless device 110, as shown in FIGS. 5A and 5B; cameras 530 and 540 are positioned on a top of wireless device 110, as shown in FIG. 5C, and cameras 610, 620, and/or 630 are positioned on a back pane (or back plate) of wireless device 110, as shown in FIGS. 6A and 6B. Cameras 510, 520, 530, 540, 610, 620, and/or 630 may be camera 115 shown as being associated with wireless device 110 in FIG. 1. The examples shown are not meant to be limiting and it may be understood that any number of cameras, mirrors, or other image or signal capturing devices may be associated with wireless device 110 and may be positioned in any location on any surface of wireless device 110.

In an aspect, one possible form factor, shown in FIG. 5A, is a single camera 510 positioned on a beveled edge of wireless device 110, such that camera 510 can capture environmental signals representing actual images when wireless device 110 is oriented in either portrait or landscape mode. More particularly, and for example, the angle of the beveled edge of wireless device 110, as shown in FIG. 5A, may be an angle (e.g., 15 to 45 degrees from the horizontal) that compensates for an angle at which user 105 may hold wireless device 110 (e.g., also 15 to 45 degrees from the horizontal).

In an aspect, one possible form factor, shown in FIG. 5B, is a single camera 520 positioned on the back and/or in a corner of wireless device 110, such that the single camera 520 may capture environmental signals representing actual images regardless of whether wireless device 110 is in portrait or landscape mode.

In an aspect, one possible form factor, shown in FIG. 5C, is two cameras 530 and 540 positioned on the top of wireless device 110, such that the cameras 530 and 540 may capture environmental signals representing actual images when the top of wireless device 110 is positioned to face forward (e.g., away from the user). More particularly, cameras 530 and 540 are positioned at the apex of the downside corner of wireless device 110 and facing forward. In an aspect (not shown), one possible form factor may include a single one of cameras 530 and 540.

In an aspect, one possible form factor, shown in FIG. 6A, is a single fixed camera 610 on one side of wireless device 110 (e.g., the back side or opposite side from the screen). In an aspect, one possible form factor, shown in FIG. 6B is more than one camera, cameras 620 and 630, fixed on more than one side of wireless device 110. More particularly, camera 620 is positioned on a top portion of the back side or opposite side from the screen of wireless device 110 and camera 630 is positioned on a side portion of the back side or opposite side from the screen of wireless device 110 so that one camera is always in an “up” position regardless of whether wireless device 110 is in use in portrait or landscape mode. In an aspect (not shown), wireless device 110 may be configured to have one or more cameras on a side, top, corner, or edge, of wireless device 110 in addition to, or instead of having one or more cameras situated as shown in FIGS. 5A, 5B, 5C, 6A, and/or 6B. Further, in an aspect, one or more of the cameras positioned on wireless device 110 (e.g., the examples shown in FIGS. 5A, 5B, 5C, 6A, and/or 6B, or otherwise), may be fixed, adjustable, or a combination of the two.

In an optional aspect, any one (or more) of cameras 510, 520, 530, 540, 610, 620, and 630 may include a gyroscopic lens such that the lens (and/or camera) may be configured to rotate, as shown by the dotted lines in FIGS. 5A, 5B, 5C, 6A, and 6B, in order to adjust the angle at which the camera(s) may capture environmental signals representing actual images. For example, the lens(es) and/or camera(s) may have a default, or pre-set, or last used angle, and an angle of the lens(es) and/or camera(s) may be adjusted from the default, pre-set, or last used angle. Such adjustments may be made in order to ensure that the camera faces front (or forward) when the wireless device 110 is in either portrait or landscape mode such that the actual images appear to be taken from the perspective of user 105 if he or she were looking straight ahead.

For example, a camera and/or lens may be adjustable in order to compensate for various angles at which user 105 may hold the device while moving through (or being present in) physical environment 100. In a non-limiting example, if user 105 is holding wireless device 110 at a 30 degree angle relative to the ground (as shown in FIGS. 5A, 5B, and 5C, for example), one or more cameras and/or lenses associated with wireless device 110 may be rotated and/or adjusted (automatically, configurably, and/or manually) from, e.g., a default or last-used angle, so that actual images represented by environmental signals captured by the one or more cameras are still situated as if wireless device 110 were being held by user 105 at a 90 degree angle relative to the ground. As such, and in the example, a camera and/or lens would have to be adjusted 60 degrees to compensate for the 30 degree angle at which wireless device 110 was currently being held. In an aspect, cameras (and/or lenses) 510, 520, 530, 540, 610, 620, and/or 630 may rotate based on automatic and/or user- or application-configurable adjustable angles. In an aspect, any one of the cameras 510, 520, 530, 540, 610, 620, and 630 may be permanently (or semi-permanently) affixed to wireless device 110. In other words, a camera attached to wireless device 110 is part of the form factor of wireless device 110 and is installed during manufacturing of wireless device 110. In some cases, a camera may be designed, and installed, to fit wireless device 110 specifically for the applications described herein. In another aspect, any one of cameras 510, 520, 530, 540. 610, 620, and 630 may be acquired by a user separately (e.g., after-market) from the acquisition of wireless device 110 and, as such, may be connected (permanently, semi-permanently, or temporarily) to wireless device 110 by the user or a technician.

In an aspect, a camera and/or lens may be configured to dynamically adjust its angle using, for example, gyroscope and/or accelerometer sensor feeds (which may be part of the device). In an aspect, and for example, the optics of a movable camera and/or lens may be recessed into the back pane of wireless device 110 to allow for independent angle movement such that a form factor of wireless device 110 can maintain a flat back surface. In an aspect where wireless device 110 includes a non-movable camera and/or lens, wireless device 110 may prompt user 105 to adjust the angle at which she is holding wireless device 110 when the actual images (corresponding to the captured environmental signals) are determined to not accurately represent a normal view of the physical environment 100 as would be seen by user 105 if she were not focused on wireless device 110. For example, the actual images (represented by the captured environmental signals) are determined to include an image of only the sky or the sidewalk.

In an aspect, any one of cameras 510, 520, 530, 540, 610, 620, and 630 may also use a reflective surface (e.g., mirror) that may be attached (temporarily, semi-permanently, or permanently) to wireless device 110 to adjust an angle of actual images represented by the environmental signals captured by the one or more cameras without adjusting the physical angle of the camera or its lens.

In an aspect, any one of cameras 510, 520, 530, 540, 610, 620, and 630 may capture environmental signals representing actual images such that the actual images have a lenticular effect. A lenticular effect is one whereby different images are magnified and/or shown when an image is viewed from slightly different angles. Some, non-limiting, common examples of an image with a lenticular effect may be images that include an illusion of depth and images that appear to change or move as the image is viewed from different angles. In an aspect, any one of cameras 510, 520, 530, 540, 610, 620, and 630 may be configured to provide a lenticular or similar visual effect using a lenticular lens, a non-lenticular lens configured to rotate and/or adjust, a gyroscopic lens, and/or the like. In an aspect, a lenticular effect may be a feature of wireless device 110 that is configurable and/or adjustable based on a user preconfiguration or user-provided input. In another aspect, a lenticular effect may be a default, or manufacturer-set, feature of wireless device 110. In another aspect, instead of, or in addition to, cameras 510, 520, 530, 540, 610, 620, and/or 630 having a lenticular or similar visual effect, a lenticular effect may be provided by screen 120. In such an aspect, a virtual visual effect may be produced by the angle of vision (e.g., the angle at which user 105 views screen 120) to the angle of wireless device 110.

In a non-limiting example, if user 105 is holding wireless device 110 at a particular angle (e.g., 30%) relative to the ground, and a lenticular feature of wireless device 110 is activated, an opacity level of images (e.g., actual image 210 and/or application rendering 220) displayed on screen 120 may change as the angle at which user 105 holds wireless device 110 changes. For example, user 105 can slightly adjust the angle at which she is holding wireless device 110 (e.g., relative to the ground or the horizontal) from, for instance, 30% to 32% to 28%, in order to view different aspects of application rendering 210 and actual image 220 and/or to adjust the opacity level of application rendering 210 and/or actual image 220 as displayed on screen 120.

In an aspect, wireless device 110 may be configured to include an image stabilization (IS) feature that is tuned to the cadence of user 105 as she walks. For example, if user 105 is walking while using wireless device 110, wireless device 110 may experience slight movement (e.g., bouncing up and down, side to side, and/or the like). More particularly, and for example, by using wireless device 105 while walking, user 105 may introduce instability to wireless device 110 and, as such, may cause any environmental signals captured by camera 115 to be received in an unstable manner leading to blurry or otherwise less than useful actual images. In an aspect, an image stabilization feature may be configured to use the cadence and/or gait of user 105 to compensate for, and/or correct, any instability in capturing environmental signals such that the actual images may not be blurry or otherwise problematic. In an aspect, the image stabilization feature may be configured with a particular cadence and/or gait of user 105 and/or may learn the cadence and/or gait of user 105. In another aspect, the image stabilization feature may be configured with, or may learn, cadences and/or gates of multiple users of wireless device 110.

In an aspect, and for example, in order to compensate for any instability at wireless device 110, the image stabilization feature may be configured to move wireless device 110 and/or camera 115, in a horizontal, vertical, and/or lateral direction that is opposite from any destabilizing movement induced by the movement (e.g., walking) of user 105. In an aspect, the destabilizing movement may be compensated by the image stabilization feature in one, two, or three dimensions. In an aspect, the image stabilization feature may be performed on camera 115 (e.g., adjust an angle or rotation of camera 115 to compensate for the movement of user 105), a lens of camera 115 (e.g., adjust an angle or rotation of the lens to compensate for the movement of user 105), and/or during the rendering of any actual images represented by environmental signals captured by camera 115.

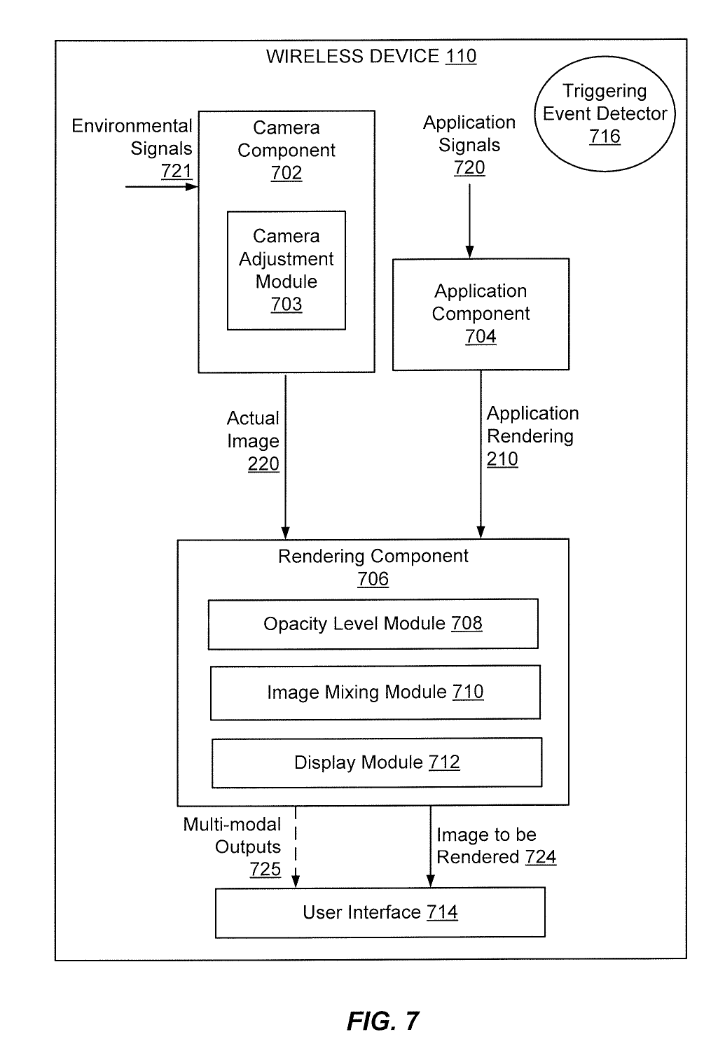

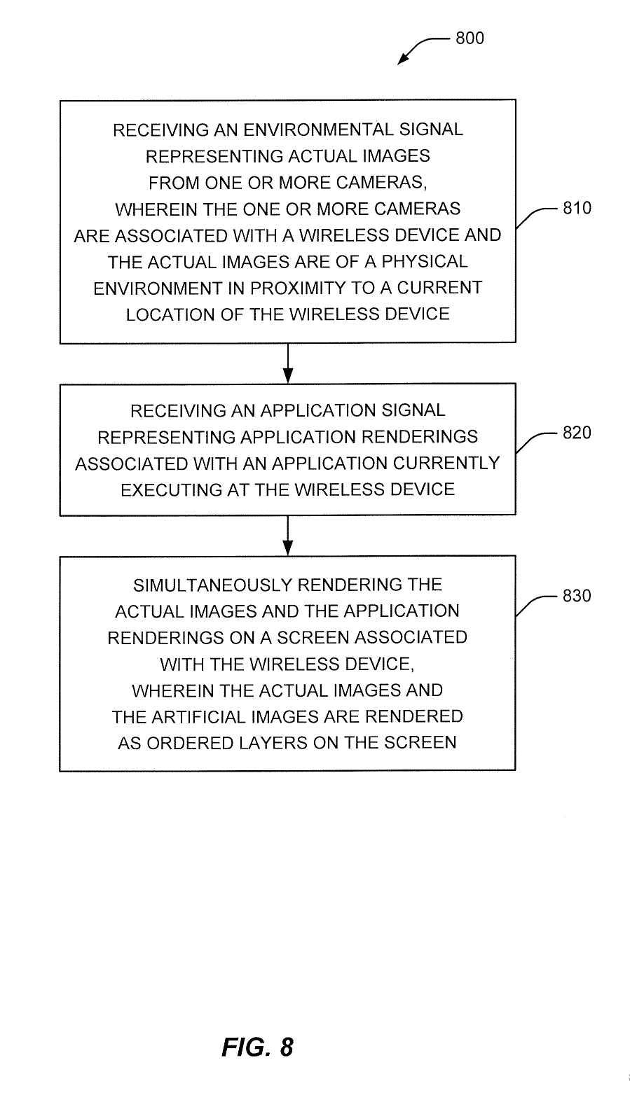

Referring to FIGS. 7 and 8, a method 800 for providing a heads-down display at wireless device 110 may be performed by camera component 702, camera adjustment module 703, application component 704, rendering component 706, opacity level module 708, image mixing module 710, display module 712, user interface 714, and/or triggering event detector 716.

At 810, the method 800 includes receiving an environmental signal representing actual images from one or more cameras, wherein the one or more cameras are associated with a wireless device and the actual images are of a physical environment in proximity to a current location of the wireless device. For example, camera component 702 may be configured to receive environmental signals 721 representing actual images of physical environment 100, which is in proximity to a current location of wireless device 110, from camera 115. In an aspect, camera 115 may be associated with wireless device 110 (as described with respect to cameras 510, 520, 530, 540, 610, 620, and/or 630 of FIGS. 5A, 5B, 5C, 6A, and 6B).

In an aspect, camera component 702 may be configured to receive environmental signals 721 from one or more cameras mounted to wireless device 110 on a beveled edge (as shown, for example, in FIG. 5A) having an angle relative to screen 120 to cause the one or more cameras to face forward relative to screen 120 of wireless device 110 when wireless device 110 is held by user 105 in either one of a portrait or a landscape orientation. In an aspect, and non-limiting example, the angle of the beveled edge relative to the screen 120 of wireless device 110 may be between 10 and 15 degrees relative to a horizontal (e.g., the ground) to compensate for an angle at which wireless device 110 is held by user 105 relative to the horizontal.

In an aspect, camera component 702 may be configured to receive environmental signals 721 from one or more cameras mounted to wireless device 110 on one or more edges of the wireless device 110 that face forward relative to the screen 120 when wireless device 120 in either one of a portrait or a landscape orientation (as shown, for example, in FIG. 6B). In an aspect, camera adjustment module 703 may be configured to adjust the one or more cameras at various angles relative to screen 120 of wireless device 110 (as shown in FIGS. 5A, 5B, 5C, 6A, and 6B). The cameras may be adjusted by camera adjustment module 703 automatically, dynamically, or manually. In an aspect, camera component 702 may be configured to receive environmental signals 721 from one or more cameras that include an attachable reflective surface and camera adjustment module 703 may be configured to use the reflective surface (or an environmental signal captured after being reflected off the reflective surface) to adjust an angle of the received environmental signals 721.

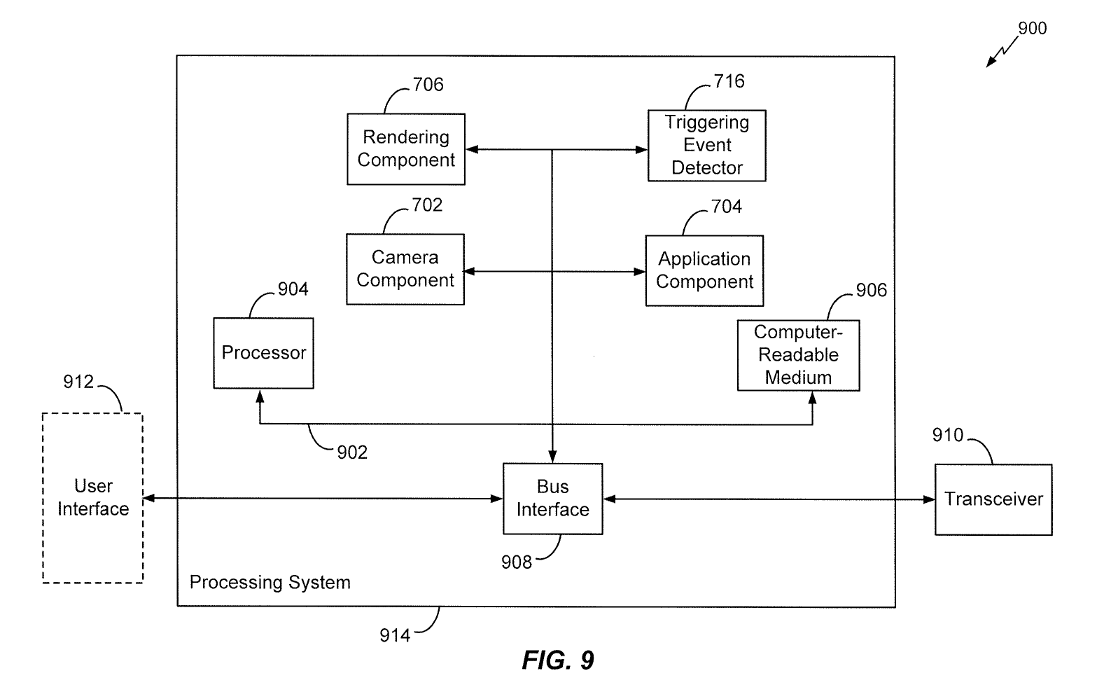

At 820, the method 800 includes receiving an application signal representing application renderings associated with an application currently executing at the wireless device. For example, application component 704 may be configured to receive application signals 720 associated with an application currently executing at wireless device 110. The application may be executed by a processor (e.g., processor 904 of FIG. 9) at wireless device 110 and may be stored at wireless device 110 in a computer-readable medium (e.g., computer-readable medium 906 of FIG. 9).

At 830, the method 800 includes simultaneously rendering the actual images and the application renderings on a screen associated with the wireless device, wherein the actual images and the application renderings are rendered as ordered layers on the screen. For example, camera component 702 may be configured to provide actual image 220 (which may be generated by camera component 702 based on environmental signals 721) to rendering component 706. For example, application component 704 may be configured to provide application rendering 210 (which may be generated by application component 704 based on application signals 720) to rendering component 706. Rendering component 706 may be configured to receive actual image 220 and application renderings 210.

Rendering component 706 includes opacity level module 708 configured to determine a level of opacity to be used when rendering actual image 220 based on at least one of a default setting, a previously-set user input, a newly-provided user input, and information related to the environment. In an aspect, the information related to the environment may be a trigger event (e.g., determination that a dangerous situation exists in physical environment 100), which may be detected by triggering event detector 716, which provides an indication that an increased risk of danger exists if actual image 220 is not rendered on screen 120 with at least a certain level of opacity.

Rendering component 706 includes image mixing module 710 configured to mix actual image 220 and application rendering 210 in order to prepare for rendering one, or both, of actual image 220 and application rendering 210, to screen 120 of wireless device 110. Rendering component 706 may include display module 712 configured to receive information related to opacity level from opacity level module 708 and a mixed image from image mixing module 710 and, based thereon, simultaneously render, via user interface 714, the actual image 220 and the application rendering 210 on screen 120 associated with wireless device 110 such that actual image 220 and application rendering 210 are rendered as ordered layers on screen 120.

In an aspect, rendering component 706 may be configured to render the actual image 220 as an ordered layer over a portion of the rendered application rendering 210. In an aspect, the portion is at least one of half of screen 120, less than half of screen 120, more than half but less than all of screen 120, a top portion of screen 120, a bottom portion of screen 120, a left portion of screen 120, a right portion of screen 120, and a center portion of screen 120. In an aspect, rendering component 706 may be configured to render actual image 220 with a level of opacity over the rendered application rendering 210 such that the ordered layers are ordered based on the level of opacity of the actual image 220. In an aspect, rendering component 706 may be configured to render actual image 220 and application rendering 210 as ordered layers on different parts of screen 120.

In an optional aspect (not shown), the method 800 may include providing multi-modal (e.g., visual, haptic, and/or audio) outputs to provide awareness of the physical environment to a user of the wireless device. For example, rendering component 706 may be configured to provide multi-modal outputs 725 to user interface 714 in order to provide an alternative, or additional, way for user 105 to be made aware of physical environment 100.

In an optional aspect (not shown), the method 800 may include determining that wireless device 110 is positioned at an angle that is within a range of angles related to providing the heads-down display and/or wireless device 110 is moving relative to a forward position of wireless device 110. For example, the heads-down display may be provided at wireless device 110 based on a determination that the wireless device 110 is being held by user 105 at an angle that may make it useful for the heads-down display feature to be enabled and/or that wireless device 110 is moving in a forward direction (e.g., user 105 is using wireless device 110 while walking down the street). In an aspect, triggering event detector 716 may be configured to make such a determination. In an aspect, and in response to the determination, rendering component 706 may be configured to simultaneously render the actual image 220 and the application renderings 210 based on the determination.

In an aspect, camera component 702, camera adjustment module 703, application component 704, rendering component 706, opacity level module 708, image mixing module 710, display module 712, user interface 714, and/or triggering event detector 716 may be hardware components physically included within wireless device 110. In another aspect, camera component 702, camera adjustment module 703, application component 704, rendering component 706, opacity level module 708, image mixing module 710, display module 712, user interface 714, and/or triggering event detector 716 may be software components (e.g., software modules), such that the functionality described with respect to each of the components and modules may be performed by a specially-configured computer, processor (or group of processors), and/or a processing system (e.g., processor 904 of FIG. 9), included within wireless device 110, executing one or more of the components or modules. Further, and in an aspect where the components or modules of wireless device 110 are software modules, the software modules may be downloaded to wireless device 110 from, e.g., a server or other network entity, retrieved from a memory or other data store internal to wireless device 110 (e.g., computer-readable medium 906 of FIG. 9), and/or accessed via an external computer-readable medium (e.g., a CD-ROM, flash drive, and/or the like).

Referring to FIG. 9, an example of a hardware implementation for an apparatus 900 employing a processing system 914 having aspects configured to provide a heads-down display at wireless device 110. In an aspect, apparatus 900 may be wireless device 110 of FIG. 1, including camera component 702, camera adjustment module 703, application component 704, rendering component 706, opacity level module 708, image mixing module 710, display module 712, user interface 714, and triggering event detector 716.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors, represented generally by the processor 904 and a computer-readable media, represented generally by the computer-readable medium 906. The bus 902 may link camera component 702, camera adjustment module 703, application component 704, rendering component 706, opacity level module 708, image mixing module 710, display module 712, user interface 714, and triggering event detector 716. The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over a transmission medium. A user interface 912, which may the same as or similar to user interface 714, may be a keypad, display, speaker, microphone, joystick, and/or the like.

The processor 904 is responsible for managing the bus 902 and general processing, including the execution of software stored on the computer-readable medium 906. The software, when executed by the processor 904, causes the processing system 914 to perform the various functions described herein for any particular apparatus. More particularly, and as described herein, camera component 702, camera adjustment module 703, application component 704, rendering component 706, opacity level module 708, image mixing module 710, display module 712, user interface 714, and triggering event detector 716 may be software components (e.g., software modules), such that the functionality described with respect to each of the components or modules may be performed by processor 904.

The computer-readable medium 906 may also be used for storing data that is manipulated by the processor 904 when executing software, such as, for example, software modules represented by camera component 702, camera adjustment module 703, application component 704, rendering component 706, opacity level module 708, image mixing module 710, display module 712, user interface 714, and triggering event detector 716. In one example, the software modules (e.g., any algorithms or functions that may be executed by processor 904 to perform the described functionality) and/or data used therewith (e.g., inputs, parameters, variables, and/or the like) may be retrieved from computer-readable medium 906.

More particularly, the processing system further includes at least one of camera component 702, camera adjustment module 703, application component 704, rendering component 706, opacity level module 708, image mixing module 710, display module 712, user interface 714, and triggering event detector 716. The components and modules may be software modules running in the processor 904, resident and/or stored in the computer-readable medium 906, one or more hardware modules coupled to the processor 904, or some combination thereof.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA, TD-SCDMA, LTE, and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. A storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for providing a heads-down display on a wireless device, comprising:
receiving an environmental signal representing actual images from one or more cameras, wherein the one or more cameras are associated with the wireless device and the actual images are of a physical environment in proximity to a current location of the wireless device;
receiving an application signal representing application renderings associated with an application currently executing at the wireless device; and
simultaneously rendering the actual images and the application renderings on a screen associated with the wireless device, wherein the actual images and the application renderings are rendered as ordered layers on the screen.

2. The method of claim 1, wherein the rendering further comprises rendering the actual images as an ordered layer as an overlay on top of a portion of the rendered application renderings, wherein the portion is at least one of half of the screen, less than half of the screen, more than half but less than all of the screen, a top portion of the screen, a bottom portion of the screen, a left portion of the screen, a right portion of the screen, and a center portion of the screen.

3. The method of claim 1, wherein the rendering further comprises rendering the actual images with a level of opacity over the rendered application renderings, wherein the ordered layers are ordered based on the level of opacity of the actual images.

4. The method of claim 3, wherein the level of opacity is determined based on at least one of a default setting, a previously-set user input, a newly-provided user input, and information related to the environment.

5. The method of claim 4, wherein the information related to the environment is a trigger event that provides an indication that an increased risk of danger exists if the actual images are not rendered on the screen or the actual images are not rendered with a high level of opacity.

6. The method of claim 1, wherein the rendering further comprises rendering the actual images and the application renderings as ordered layers on different parts of the screen.

7. The method of claim 1, wherein receiving the environmental signal comprises receiving from one or more cameras mounted to the wireless device on a beveled edge having an angle relative to the screen to cause the one or more cameras to face forward relative to the screen of the wireless device in either one of a portrait or a landscape orientation.

8. The method of claim 7, wherein the angle relative to the screen is between 10 and 15 degrees relative to a horizontal.

9. The method of claim 7, wherein the one or more cameras are positioned to compensate for an angle at which the wireless device is held by a user relative to the ground.

10. The method of claim 1, wherein receiving the environmental signal comprises receiving from one or more cameras mounted to the wireless device on one or more edges of the wireless device that face forward relative to the screen of the wireless device in either one of a portrait or a landscape orientation.

11. The method of claim 1, wherein the one or more cameras are adjustable at various angles relative to the screen of the wireless device.

12. The method of claim 1, wherein receiving the environmental signal comprises receiving from one or more cameras that include an attachable reflective surface that can be used by the one or more cameras to adjust an angle of the received environmental signal.

13. The method of claim 1, further comprising determining that at least one of the wireless device is positioned at an angle that is within a range of angles related to providing the heads-down display and the wireless device is moving relative to a forward position of the wireless device, wherein the simultaneously rendering the actual images and the application renderings are based on the determining.

14. The method of claim 1, wherein the actual image has a lenticular effect, and wherein the lenticular effect is caused by at least one of a lens of the one or more cameras or the screen.

15. The method of claim 1, wherein the rendering further comprises:
detecting movement of the wireless device in one or more dimensions;
determining that the wireless device is unstable based on the detecting; and
performing image stabilization to compensate for the determining.

16. A computer program product for providing a heads-down display on a wireless device, comprising:
a non-transitory computer-readable medium comprising:
code for causing a computer to:
receive an environmental signal representing actual images from one or more cameras, wherein the one or more cameras are associated with the wireless device and the actual images are of a physical environment in proximity to a current location of the wireless device;
receive an application signal representing application renderings associated with an application currently executing at the wireless device; and
simultaneously render the actual images and the application renderings on a screen associated with the wireless device, wherein the actual images and the application renderings are rendered as ordered layers on the screen.

17. A wireless device apparatus for providing a heads-down display, comprising:
one or more cameras associated with the wireless device and configured to receive an environmental signal representing actual images, wherein the actual images are of a physical environment in proximity to a current location of the wireless device;
an application component configured to receive an application signal representing application renderings associated with an application currently executing at the wireless device; and
a rendering component configured to simultaneously render the actual images and the application renderings on a screen associated with the wireless device, wherein the actual images and the application renderings are rendered as ordered layers on the screen.

18. The apparatus of claim 17, wherein the rendering component is further configured to render the actual images as an ordered layer as an overlay on top of a portion of the rendered application renderings, wherein the portion is at least one of half of the screen, less than half of the screen, more than half but less than all of the screen, a top portion of the screen, a bottom portion of the screen, a left portion of the screen, a right portion of the screen, and a center portion of the screen.

19. The apparatus of claim 17, wherein the rendering component is further configured to render the actual images with a level of opacity over the rendered application renderings, wherein the ordered layers are ordered based on the level of opacity of the actual images.

20. The apparatus of claim 19, wherein the level of opacity is determined based on at least one of a default setting, a previously-set user input, a newly-provided user input, and information related to the environment.

21. The apparatus of claim 17, wherein the rendering component is further configured to render the actual images and the application renderings as ordered layers on different parts of the screen.

22. The apparatus of claim 17, wherein the one or more cameras are mounted to the wireless device on a beveled edge having an angle relative to the screen to cause the one or more cameras to face forward relative to the screen of the wireless device in either one of a portrait or a landscape orientation.

23. The apparatus of claim 22, wherein the angle relative to the screen is between 10 and 15 degrees relative to a horizontal.

24. The apparatus of claim 23, wherein the one or more cameras are positioned to compensate for an angle at which the wireless device is held by a user relative to the ground.

25. The apparatus of claim 17, wherein the one or more cameras are mounted to the wireless device on one or more edges of the wireless device that face forward relative to the screen of the wireless device in either one of a portrait or a landscape orientation.

26. The apparatus of claim 17, wherein the one or more cameras are adjustable at various angles relative to the screen of the wireless device.

27. The apparatus of claim 17, wherein the one or more cameras include an attachable reflective surface that can be used by the one or more cameras to adjust an angle of the received environmental signal.

28. The apparatus of claim 17, further comprising a triggering event detector configured to determine that at least one of the wireless device is positioned at an angle that is within a range of angles related to providing the heads-down display and the wireless device is moving relative to a forward position of the wireless device, wherein the rendering component is further configured to the simultaneously render the actual images and the application renderings are based on the determination by the triggering event detector.

29. The apparatus of claim 17,
wherein the actual image has a lenticular effect, and
wherein the lenticular effect is caused by at least one of a lens of the one or more cameras or the screen.

30. The apparatus of claim 17, wherein the rendering component is further configured to:
detect movement of the wireless device in one or more dimensions;
determine that the wireless device is unstable based on the detection; and
perform image stabilization to compensate for the determined instability.
